(19) United States
(12) Patent Application Publication
(10) Pub. No.: US 2001/0036619 A1
(43) Pub. Date: Nov. 1, 2001

(54) Training method

(76) Inventor: Patrick A. Kerwin, Dallas, TX (US)

Correspondence Address: David W. Carstens, Carstens, Yee & Cahoon, L.L.P., P.O. Box 802334, Dallas, TX, 75380, US

(21) Appl. No.: 09/815,223

(22) Filed: Mar. 22, 2001

Related U.S. Application Data
(63) Continuation-in-part of application No. 09/429,682, filed on Oct. 28, 1999.

(51) Int. Cl. G09B 19/00

(52) U.S. Cl. 434/118

(57) ABSTRACT

A training system including a visual display, a computer, a mouse, and a keyboard for data entry into the system, such data entry including problems presented as situations/simulations tailored to the particular type of training to be conducted together with trainee responses to questions relating to such situations/simulations. In one embodiment, provision is made for the trainees to prepare and record their own narrative solutions to such situations/simulations, following which the system presents sets of multiple choice solutions and asks the trainees to select what they believe are the best solutions from among those that are presented. In another embodiment, the system requires a student to first complete a preliminary multiple-choice test before proceeding to preparing and recording a narrative description of his proposed solution to the indicated problem. The system critiques trainee selections and narrative responses. For each situation/simulation, if the trainee provides the optimum solution, the system identifies the reasons why that selection or narrative description is optimal and repeats the related situation/simulation at least once more after moving on to another situation/simulation before the training session is completed. If the optimum solution is not selected or provided, the system repeats its request for identification of the optimum solution, critiquing each answer until the correct one is provided.

### RELATED APPLICATIONS

The present invention is a continuation-in-part of U.S. Non-Provisional Ser. No. 09/429,682 filed on Oct. 28, 1999. The contents of the preceding application is incorporated herein by reference.

### BACKGROUND OF THE INVENTION

1. Technical Field

The present invention relates to a method for training personnel and, specifically to a supervised or individual training method whereby the trainee is taught by participation in interactive multiple choice and essay testing exercises.

2. Description of the Related Art

A variety of proposals have previously been made to automate the training needs of employee personnel, illustrative of which are those contained in the publication “Tutor Texts”, Copyright 1958 by Norman A. Crowder and published by Doubleday & Company of Garden City, N.Y. In accordance with this proposal, one or more books introduce subject material to a reader, after which the reader is asked to answer multiple-choice questions about the material. A page reference is provided for the reader to review his answer, whether correct or incorrect. If correct, he then is instructed to continue with more new material. If incorrect, reference is made to an explanation and the reader is asked to again select the correct answer to the multiple choice question.

Other prior proposals include the use of television in conducting training, illustrative of which is U.S. Pat. No. 3,566,482 granted to C. A. Morchand Mar. 2, 1971. According to that proposal, a plurality of selector switches are coupled to selectively control presentation of a display on the cathode ray tube of a television receiver. In operation, a question and multiple choice answer can be presented within a first portion such as the top quarter segment of the cathode ray tube, the remainder of the tube being blank. A student, selecting what he regards to be the correct answer by operating one of the selector switches, “unblanks” a portion of the blank section of the tube to display information pertaining to the correctness of the selection.

Another proposal is that of U.S. Pat. No. 3,606,688 granted to Jacob Zawels et. al., on Sep. 21, 1971. According to this patent, students respond to questions appearing on their output screens and each obtains a personal immediate indication as to whether the answer selected is right or wrong and, in some instances, the probable flaw in the student's reasoning if he is wrong. Likewise, a similar proposal lies within U.S. Pat. No. 3,671,668 granted to Leonard Reiffel, Jun. 20, 1972. Within said patent, there is disclosed a system for simultaneously teaching multiple students by presenting questions on a monitor screen, and each obtains a personal immediate indication as to whether he is right or wrong and, in some instances, the probable flaw in his reasoning if he is wrong.

Although the foregoing disclosures present a variety of proposals for presenting situations/questions to students and checking their responses, they do not include a requirement for students to either first prepare narrative responses prior to testing through the multiple-choice questions, or in the alternative, testing first through multiple-choice questions prior to preparing a narrative responses to posed queries. Neither do they include the feature of repetitive questioning so as to ensure that the full potential of a problem situation is recognized by the student and retained in his repertoire. Moreover, they are limited to producing a numerical score for the analysis of the trainee's comprehension, or lack thereof.

A need exists for an improved and more comprehensive self-administered teaching system that can be tailored to specific situations that will likely be encountered by the student. Further, a need exists for an improved training method that reinforces the education and training provided to the student by repetitive presentation during the training period, as opposed to a critique of test scores after the training exercise concludes.

### SUMMARY OF THE INVENTION

The present invention overcomes many of the disadvantages of prior art training methods, the most important one being the repetitive aspect of the program while the training is taking place. Likewise, the present invention provides for the training administrator to create and test situations and simulations specific to his business. By requiring a student to prepare and record a narrative description of his proposed solution to indicated problems before proceeding to a multiple choice test, it requires the student to “prove” his knowledge. Alternatively, the system can also require a student to first complete a preliminary multiple-choice test before proceeding to preparing and recording a narrative description of his proposed solution to the indicated problem. Most importantly, the present invention allows the trainer to select the degree of repetitive questioning for which a specific level of student knowledge retention is required.

The improved training system includes a visual display, a computer, a mouse and a keyboard for data entry into the system, such data entry including sets of problem situations tailored to the particular type of training to be conducted together with trainee responses to questions relating to such problem situations. The system can be implemented over a computer network or over the Internet.

The system is designed to present a plurality of problem situations/simulations for the trainee to consider. In one embodiment, the system first requests the trainee to prepare and record their own narrative solution to a problem situation. The system then presents a set of multiple-choice alternatives and/or answer blanks for typed responses or “school” solutions and asks the trainees to select what they believe is the best solution from among those presented. The system critiques the trainee selections and/or typed responses. If the optimum solution has been selected, the system identifies the reasons why that selection is optimal before moving on to another problem situation. If the optimum solution has not been selected, the system repeats its request for identification of the optimum solution, critiquing each answer until the correct one has been selected.

In another embodiment, the system first presents a multiple-choice question similar to the method of the previously mentioned embodiment and thereafter, upon successful completion of the multiple-choice phase, requests the trainee to prepare and record narrative solutions to the presented problem situations. The system then analyzes the trainee's narrative typed responses to determine the correctness of the trainee's answer based upon the number of keywords appearing in the trainee's response.

It is one general object of the invention to improve computer based training systems. It is another object of the invention to improve student understanding of tailored situations/simulations and relevant considerations applicable thereto. It is yet another object of the invention to reduce the length of time required to train personnel. It is still another object of the invention to achieve a higher level of learning in a self-administered computer-based training system. It is yet another object of the invention to reduce management time required for employee training.

Thus, in accordance with one feature of the invention, teaching of basic required information is included and provision is made for customizing the information taught by including the capability for a user/administrator to add problem situations/simulations tailored to his/her individual work environment. As a result, the training is focused on teaching representative specifics of the intended environment. Additionally, sets of general problem situations/simulations may be provided in addition to those tailored to the particulars of the intended environment.

In accordance with another feature of the invention, trainees are instructed to first prepare narrative descriptions of their proposed actions/solutions to situations/simulations before being presented with multiple choice questions, thereby providing enhanced learning and the ability to monitor trainee progress. As well, the trainee narrative descriptions can be recorded in system memory to provide an easily retrievable record and facilitate review by supervisory personnel. Additionally, the narrative descriptions may be evaluated to provide feedback directly to the trainee by displaying an indication of an award.

After completing the foregoing narrative descriptions, trainees are next presented with a set of multiple-choice questions relating to the then-presented situation/simulation and instructed to select the best answer, after which considerations relating to the selected answer are displayed. If the foregoing answer is incorrect, after considerations relating to the selected answer are displayed, the trainee is again instructed to enter a typed response and/or choose the correct response among the multiple-choice solutions until the correct typed response is entered and/or the correct multiple choice answer is chosen.

In accordance with another feature of the invention, trainees are first presented with a multiple-choice question before being instructed to prepare a narrative description of proposed actions/solutions to the situation/simulation. The trainee is presented with a situation/simulation and an accompanying set of multiple-choice answers and instructed to select the best answer. Upon selecting an answer, considerations relating to the correct answer are displayed. Upon selecting the correct answer, the trainee is allowed to proceed to the next phase of testing. However, if the foregoing selection is incorrect, the trainee is again instructed to choose the correct response from among the remaining multiple-choice solutions until the correct multiple choice answer is chosen.

After completing the multiple-choice question phase, the system then requests the trainee to prepare and record a narrative solution to a presented problem situation. The system analyzes the trainee's narrative typed response for pre-defined keywords that identify the correctness of the trainee's answer to the posed query. Based upon an identification of a sufficient number of pre-defined keywords in the narrative, the system determines whether the narrative response contains a correct solution to the problem situation. If a sufficient number of keywords are contained within the narrative response, the system identifies the reasons why the response is correct before moving on to another problem situation. If the narrative response contains an insufficient number of keywords, the system will notify the trainee and either repeat the question or, alternatively, send the trainee to a related multiple-choice question to reinforce the keyword concepts.

Either methodology of the alternative features of the present invention enhances the learning process and provides the capability to monitor a trainee's progress. The trainee's narrative responses and responses to multiple-choice questions can be recorded in system memory to provide an easily retrievable record, thereby facilitating review by supervisory personnel.

A novel feature of the invention is the repetitive presentation of the same situation/simulation, including the request for a narrative description, in the event the trainee fails to enter the appropriate typed response and/or select the correct multiple choice answer. The program analyzes the trainee's narrative typed response for pre-defined keywords that identify the correctness of the trainee's answer and/or multiple choice answer to the posed query. The test administrator or designer can preset a “repeat cycle” so that a trainee is required to repeat questions or simulations until he has typed in the correct response and/or answered the multiple choice query correctly a certain number of times in a row.

Further, as questions are repeated to the user, his additional narrative answers can be automatically analyzed to determine if it contains any of the keywords presented in the optimum multiple choice answer presented to the user earlier in the session. This is an important element of the training because it determines whether the user is retaining the core elements of the correct answer.

The delivery of the present training system also contains novel business methods. For example, an employer could be allowed to create a training course for free. He would then be charged for each use of the course thereafter by an employee. Alternatively, the employer could be allowed to create a course for free, and the employees would be charged for each use. A portion of the income generated could be returned to the employer.

The ability to pre-set a “repeat-cycle” is also a novel aspect of the present invention. A “repeat cycle” requires the students to repeat questions (situations/simulations) until they have answered each one correctly a certain number of times, scored by multiple-choice response. The “repeat-cycle” can also be pre-set so that questions (situations/simulations) will continue to be re-presented until the user has answered them correctly a certain number of times in a row, scored by reading the words typed in. This repetition is important and different than merely “repeating until correct” and “a pre-set repeat-cycle” which may cause a person to repeat questions even after they have gotten them correct.

### BRIEF DESCRIPTION OF THE DRAWINGS

A more complete understanding of the method and apparatus of the present invention may be had by reference to the following detailed description when taken in conjunction with the accompanying drawings, wherein:

FIG. 1 is a overall view illustrating basic physical elements of the system;

FIGS. 2A, 2B, 2C and 2D are diagrams illustrating the sequence of steps in practicing the methods according to the invention;

FIG. 3 illustrates the use of the system in a network or Internet environment;

FIG. 4A illustrates one embodiment of the system wherein the sequence of steps includes a request for narrative response followed by a multiple-choice question;

FIG. 4B illustrates one variation of the embodiment of the system shown in FIG. 4A, wherein the sequence of steps includes a request for narrative response followed by a multiple-choice question;

FIG. 4C illustrates another embodiment of the system wherein the sequence of steps includes a multiple-choice question followed by a request for narrative response;

FIG. 5 illustrates a screen displayed to a user connecting to the invention over the Internet;

FIGS. 6A and 6B illustrate variations of screen displays showing the presentation of a question, the entered narrative response and the presentation of the multiple choice answers; and

FIGS. 7A and 7B illustrates screen displays showing the presentation of a question with its corresponding set of multiple-choice answers; followed by a request for narrative response, the entered responses, and system critiques.

### DETAILED DESCRIPTION OF THE DRAWINGS

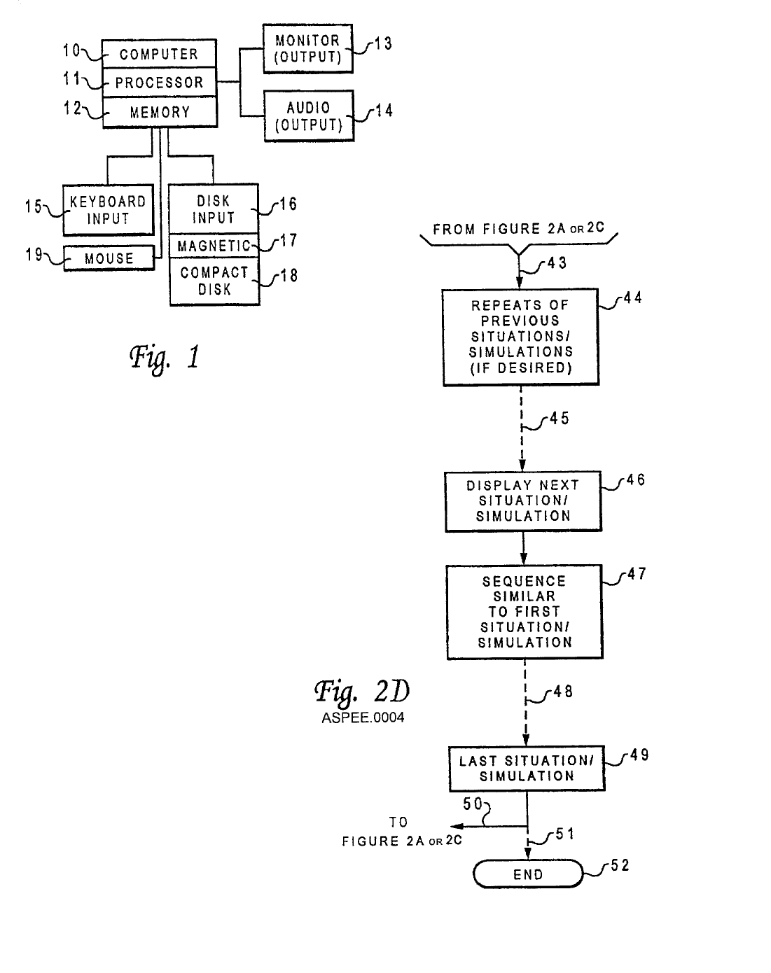

Turning to the drawings, and more particularly FIG. 1 thereof, it will be seen to depict a conventional computer 10 having a processor 11 and memory 12. Connected to computer 10 and acting as outputs therefrom are conventional video-type monitor 13 and optional conventional audio transducer (e.g., loudspeaker) 14. Connected to computer 10 as inputs thereto are conventional keyboard 15 and optional conventional magnetic disk input 17, optional conventional compact disk input 18, and mouse input 19. All of these components are conventional and well known to those skilled in the art. The learning system preferably is practiced using the foregoing system components, although it may be practiced with alternate components such as overhead projectors or projectable slides.

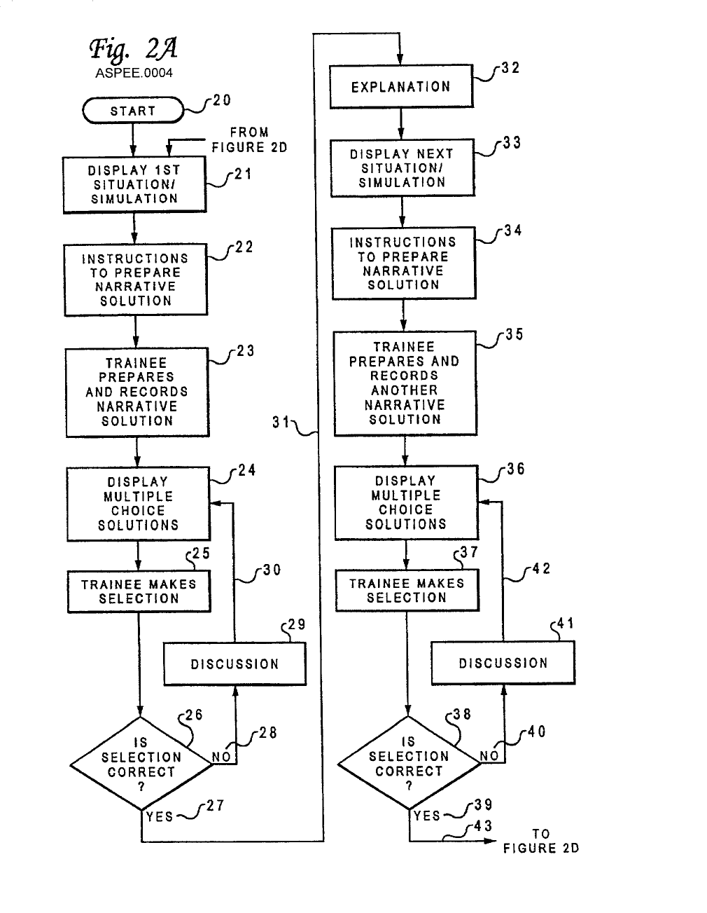

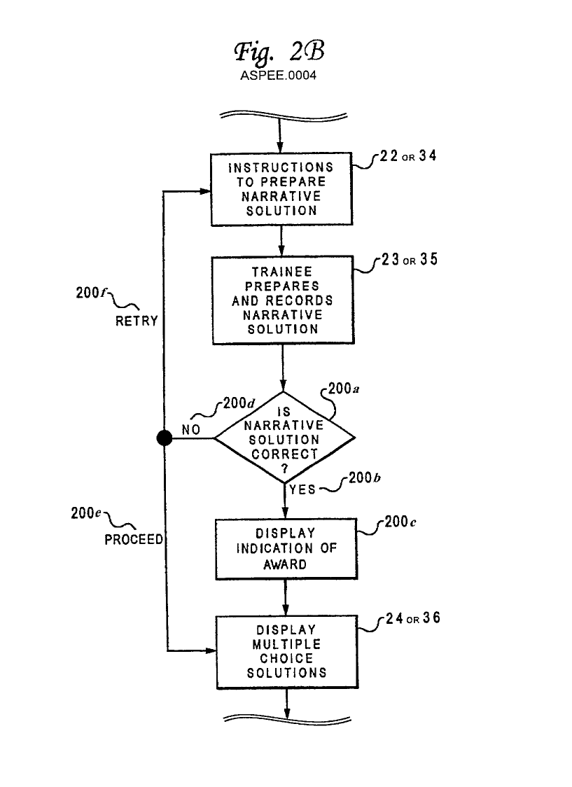

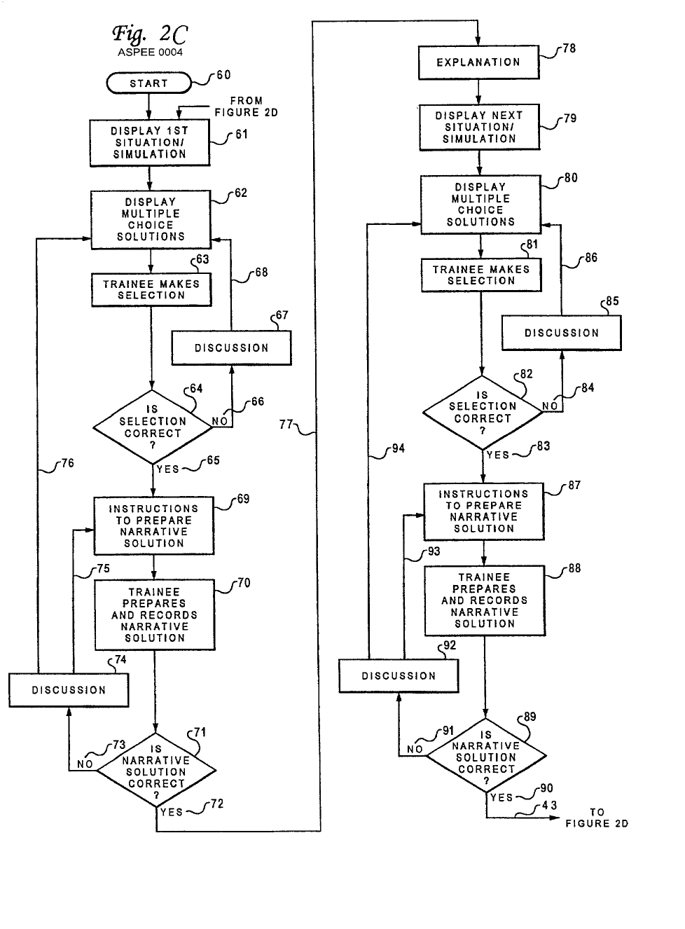

As set forth within the preferred components, initiation of system operation is represented by start rectangle 20 as set forth in FIG. 2A, or alternatively, by start rectangle 60 as set forth in FIG. 2C. This necessarily contemplates turning on the system power and loading the teaching program into active memory of the computer in accordance with principles well known in the art. When the system then is operational, monitor 13 displays the first situation/simulation as represented by rectangle 21, or in the alternative, rectangle 61. The term “situation/simulation” represent a written description of a learning incident, such as a set of circumstances that may arise in conducting the business or profession, to which the teaching/learning system is directed. An example of such a situation/simulation is as follows: “A person with whom you do not wish to speak has telephoned you. What should you do?”

Referring to FIG. 2A to FIG. 2D, in one embodiment of the invention, after the trainee has had time to read and understand the foregoing situation/simulation, he is instructed to enter into computer memory through keyboard 15 a narrative describing his proposed solution to the presented situation/simulation as represented by rectangle 22. After entering such narrative (rectangle 23), the trainee is instructed to advance the system by pressing a mouse button pointed to a screen “button”, after which the system progresses to present on monitor 13 a set of multiple-choice solutions to the first situation/simulation as represented by rectangle 24. The trainee is then instructed to make a selection from among the available solutions as represented by rectangle 25.

At this point, the question is identified by conventional logic 26 as to its accuracy whether yes 27, if it is the best answer, or no 28, or if it is not the best answer. If no 28, operation of the system then proceeds to display on monitor 13 a discussion 29 identifying why the selection was not the best, and instructs the trainee to advance the system by pressing a mouse button pointed to a screen “button”, after which the system returns (as represented by path 30) to the same set of multiple choice solutions (rectangle 24) which are again presented, and the trainee is again asked to make a selection. As with his first-time selection, if his second-time selection is inaccurate, the system returns via no answer path 28, discussion rectangle 29 and path 30 to rectangle 24. However, if the answer is now correct, the system proceeds as by yes path 27. It should be noted that the loop via no path 28 and discussion rectangle 29 may be set by the training supervisor to repeat so long as the trainee makes an incorrect choice to the multiple answer question or to repeat a finite number of times. Eventually, the trainee will run out of answers that he has not previously selected and will make a correct selection. In any event, even if the first time through the trainee makes a correct selection, the system will subsequently repeat the situation/simulation at least once as will now be evident from reference to FIG. 2D. The actual number of times the situation/simulation is repeated is at the discretion and under the control of the above-mentioned training/system administrator.

Yes 27 leads via path 31 to explanation rectangle 32 which represents a visual display on monitor 13 of considerations relevant to and supporting the correct multiple solution answer choice. Although later, the trainee is again presented at least once more with each of the previous situations/simulations as represented by a return to rectangle 21 via loop 50, in the present sequence, more situations/simulations are presented as represented by rectangle 33 which is labeled “Display Next Situation/Simulation”. The trainee is again requested to prepare and record his proposed solution (rectangle 34). After the trainee has prepared and recorded such narrative solution (rectangle 35), the current multiple choice solutions are presented to the trainee (rectangle 36), after which the trainee makes his selection as represented by rectangle 37. Logic 38 then determines whether this latest choice is correct or not. If correct, system operation progresses as represented by yes path 39. However, if the answer is incorrect as represented by no output 40, the system proceeds with discussion 41, and returns via path 42 to rectangle 36 whence operation again proceeds as previously described.

FIG. 2B illustrates a variation of the embodiment of the invention shown in FIG. 2A. Referring to FIGS. 2A and 2B, the trainee is instructed to enter into computer memory through keyboard 15 a narrative describing his proposed solution to the presented situation/simulation as represented by rectangles 22 or 34. After entering such narrative (rectangles 23 or 35), the trainee is instructed to advance the system by pressing a mouse button pointed to a screen “button”. However, as shown in FIG. 2B, under the variation of the embodiment of the invention, the program analyzes the trainee's narrative typed response for pre-defined keywords that indicate the correctness of the trainee's answer to the posed query.

Based upon an identification of pre-defined keywords in the narrative, the system determines by conventional logic 200a as to its accuracy whether yes 200b, if it contains a sufficient number of keywords, or no 200d, if it does not contain a sufficient number of keywords. If no 200d, operation of the system may advance at the discretion of the system operator via two alternative predefined paths.

If via retry path 200f, the system once again presents the same situation/simulation and instructs the trainee to enter into computer memory through keyboard 15 another narrative response describing his proposed solution to the presented situation/simulation as represented by rectangles 22 or 34. As with his first-time narrative answer, if his second-time narrative does not contain a sufficient number of pre-determined keywords, the system returns via no answer path 200d. However, if the narrative answer now contains a sufficient number of keywords, the system proceeds as by yes path 200b to display an indication of award 200c prior to proceeding on to the display of multiple choice solutions 24 or 36 as in the parent embodiment shown in FIG. 2A.

Alternatively, if via proceed path 200e, the system advances directly to display the multiple choice solutions 24 or 36 as in the parent embodiment shown in FIG. 2A. It should be noted that the loop via no path 200d may be set by the training supervisor to repeat so long as the trainee's narrative answer does not contain a sufficient number of keywords or to repeat a finite number of times prior to advancing on to display the multiple choice solutions 24 or 36 as in the parent embodiment shown in FIG. 2A.

Referring now to FIG. 2C, in another embodiment of the invention, after the trainee has had time to read and understand the foregoing situation/simulation, the system presents on monitor 13 a plurality of multiple choice solutions to the first situation/simulation as represented by rectangle 62. The trainee is then instructed to make a selection from among the available solutions as represented by rectangle 63.

The selection is identified by conventional logic 64 as to its accuracy whether yes 65, if it is the best answer, or no 66, if it is not the best answer. If no 66, operation of the system then proceeds to display on monitor 13 a discussion 67 identifying why the selection was not the best, and instructs the trainee to advance the system by pressing a mouse button pointed to a screen “button”, after which the system returns (as represented by path 68) to the same set of multiple choice solutions (rectangle 62)) which are again presented, and the trainee is again asked to make a selection. As with his first-time selection, if his second-time selection is inaccurate, the system returns via the no answer path 66, discussion rectangle 67 and path 68 to rectangle 62. However, if the answer is now correct, the system proceeds as by the yes path 65.

At this point, the system once again presents a situation/simulation and instructs the trainee to enter into computer memory through keyboard 15 a narrative response describing his proposed solution to the presented situation/simulation as represented by rectangle 69. After entering such narrative (rectangle 70), the trainee is instructed to advance the system by pressing a mouse button pointed to a screen “button.” The program then analyzes the trainee's narrative typed response for pre-defined keywords that indicate the correctness of the trainee's answer to the posed query. Based upon an identification of pre-defined keywords in the narrative, the system determines by conventional logic 71 as to its accuracy whether yes 72, if it contains a sufficient number of keywords, or no 73, if it does not contain a sufficient number of keywords. If no 73, operation of the system then proceeds to display on monitor 13 a discussion 74 identifying why the narrative statement was not correct, and instructs the trainee to advance the system by pressing a mouse button pointed to a screen “button.”

At this point, the system then returns via one of two alternative paths to again pose a query. By following path 75 the system once again presents the same situation/simulation and instructs the trainee to enter into computer memory through keyboard 15 another narrative response describing his proposed solution to the presented situation/simulation as represented by rectangle 69. By following alternative path 76, the system once again returns to the same set of related multiple choice solutions (rectangle 62) which are again presented, and the trainee is again asked to make a selection. The choice between alternative paths 75 and 76 is at the discretion and under the control of the above mentioned training/system administrator.

If path 75 is elected, the system once again presents the same situation/simulation and instructs the trainee to enter into computer memory through keyboard 15 another narrative response describing his proposed solution to the presented situation/simulation as represented by rectangle 69. As with his first-time narrative answer, if his second-time narrative does not contain a sufficient number of pre-determined keywords, the system returns via no answer path 73 to discussion rectangle 74. However, if the narrative answer now contains a sufficient number of keywords, the system proceeds as by yes path 72. It should be noted that the loop via no path 75 and discussion rectangle 74 may be set by the training supervisor to repeat so long as the trainee's narrative answer does not contain a sufficient number of keywords or to repeat a finite number of times.

If path 76 is elected, the system once again returns to the same set of related multiple choice solutions (rectangle 62) which are again presented, and the trainee is again asked to make a selection. As with his previous selections, if his selection is inaccurate, the system returns via the no answer path 66, discussion rectangle 67 and path 68 to rectangle 62. However, if the answer is now correct, the system proceeds as by the yes path 65. The test administrator or designer can preset a “repeat cycle” so that a trainee is required to repeat questions or simulations until he has typed in the correct response and/or answered the multiple choice query correctly a certain number of times in a row.

It should be noted that the loops via no paths 66 & 73 and respective discussion rectangles 67 & 74 may be set by the training supervisor to repeat so long as the trainee makes an incorrect choice to the multiple answer question, provides a narrative response with an insufficient number of keywords or to repeat a finite number of times. With regard to multiple-choice questions, the trainee will eventually run out of answers that he has not previously selected and will make a correct selection. In any event, even if the first time through the trainee makes a correct selection and includes in his narrative solution a sufficient number of keywords, the system will subsequently repeat the situation/simulation at least once as will now be evident from reference to FIG. 2D. The actual number of times the situation/simulation is repeated is at the discretion and under the control of the above-mentioned training/system administrator.

Yes 72 leads via path 77 to explanation rectangle 78 which represents a visual display on monitor 13 of considerations relevant to and supporting the correct narrative answer solution. Although later, the trainee is again presented at least once more with each of the previous situations/simulations as represented by a return to rectangle 61 via loop 50, in the present sequence, more situations/simulations are presented as represented by rectangle 79 which is labeled “Display Next Situation/Simulation”. The system once again provides a set of multiple choice solutions to the current situation/simulation as represented by rectangle 80. The trainee is again instructed to make a selection from among the available solutions as represented by rectangle 80, after which the trainee makes his selection as represented by rectangle 81. Logic 82 then determines whether this latest choice is correct or not. If correct, the system operation progresses as represented by yes answer 83. However, if the answer is incorrect as represented by no output 84, the system proceeds with discussion 85, and returns via path 86 to rectangle 80 whence operation again proceeds as previously described.

Upon correctly selecting the correct multiple choice answer, the system once again proceeds and presents the current situation/simulation and instructs the trainee to enter a narrative response describing his proposed solution to the presented situation/simulation as represented by rectangle 87. After entering such narrative response (rectangle 88), the trainee is again instructed to advance the system. The program again analyzes the trainee's narrative typed response for pre-defined keywords that identify the correctness of the trainee's answer to the currently posed query. Based upon an identification of pre-defined keywords in the narrative, the system determines by conventional logic 89 as to its accuracy whether yes 90, if it contains a sufficient number of keywords, or no 91, if it does not contain a sufficient number of keywords. If no 91, operation of the system then proceeds to display on monitor 13 a discussion 92 identifying why the narrative statement was not correct, and instructs the trainee to advance the system by pressing a mouse button pointed to a screen “button.” At this point, the system then returns via one of two alternative paths to again pose a query. If path 93 is elected, the system once again presents the same situation/simulation and instructs the trainee to enter into computer memory through keyboard 15 another narrative response describing his proposed solution to the presented situation/simulation as represented by rectangle 87, whence operation again proceeds as previously described. If path 94 is elected, the system once again returns to the same set of related multiple choice solutions (rectangle 80) which are again presented, and the trainee is again asked to make a selection. whence operation again proceeds as previously described.

It will be recalled that one of the features of the invention lies in the repetitive nature of system operation. Thus, even if a trainee answers a multiple choice question correctly and provides a narrative response containing a sufficient number of keywords the first time it is asked, he still is asked at least one more time to respond to the multiple choice question and prepare his narrative solution to the situation/simulation. It has been found that such repetition results in a substantially enhanced training experience both in regard to the level of understanding and also to a reduction in time required to achieve a high understanding level. Also, by repeated preparation of narrative descriptions of solutions to situation/simulation, a trainee becomes better prepared to apply the principles underlying the correct solutions to such variations of the situations/simulations as may be encountered in subsequent experience.

After proceeding via yes response 39 in FIG. 2A or, alternatively, yes response 90 in FIG. 2C, the system sequence proceeds as represented by path 43. At this point in system sequence, if the trainer desires to present a previous situation/simulation again, such is represented by rectangle 44 “Repeats of Previous Situations/Simulations (if desired)”. Such is presented at this point in system sequence to illustrate the fact that repeats of previous situations may be made at any desired point in system operation in addition to occurring after all the situations/simulations have been presented the first time. Ordinarily, however, it is contemplated that all or most of the situations/simulations will have been presented to the trainee before he is again presented with a previous situation.

If it is not desired at this point to repeat a previous situation, the system operation by-passes the step of rectangle 44 and proceeds as by path 45 to display the next situation/simulation (rectangle 46). The system then proceeds as described with respect to the first and second situations/simulations (rectangle 47) and, after the trainee has chosen the correct solution from among the multiple choice answers, the system continues on with successive situations/simulations (as denoted by dashed line 48) until it arrives at the last situation/simulation (rectangle 49) and all of the situations/simulations have been presented at least once. Then, at the option of the training administrator, system operation proceeds as by loop path 50 to sequentially present some or all of the situations/simulations again; or as by dashed line 48. The training administrator may also control whether the system methodology proceeds via loop path 50 to display the first situation/simulation as represented by rectangle 21 in FIG. 2A, or in the alternative embodiment, rectangle 61, in FIG. 2C.

As is well known to those skilled in the art, signaling of stop/pause may be conducted by depressing a designated key on the input keyboard 15 or clicking a button on the screen with the mouse. Such may be done at any step in the system sequence, and the system will note the point at which the sequence has stopped and be prepared to resume operation from that point if desired or be reset to the beginning if so instructed by keyboard or mouse inputs.

As previously mentioned, it is one of the features of the invention that the system provide for presentation of situations/simulations that are particularly tailored to the environment in which the trainee is expected to work. However, as will be evident to those skilled in the art, the system may also advantageously include generalized situations/simulations that are universally applicable. These may, of course, be input to system memory 12 by any of a variety of devices that are well known in the art, devices such as keyboard input 15, disk input 16, magnetic medium 17 and/or compact disk 18.

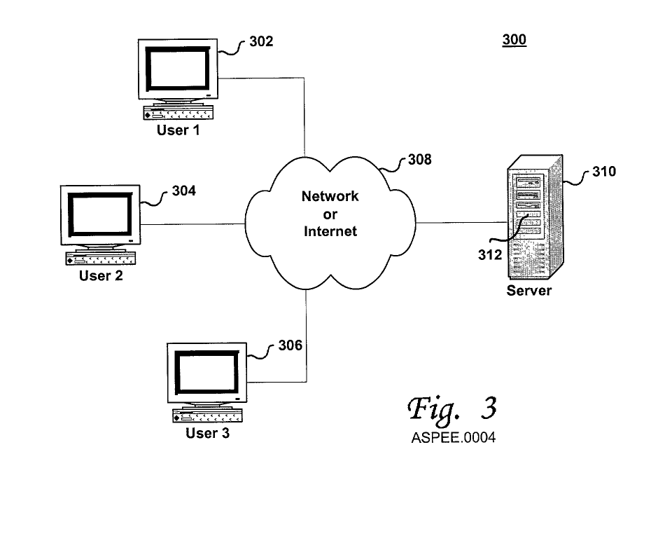

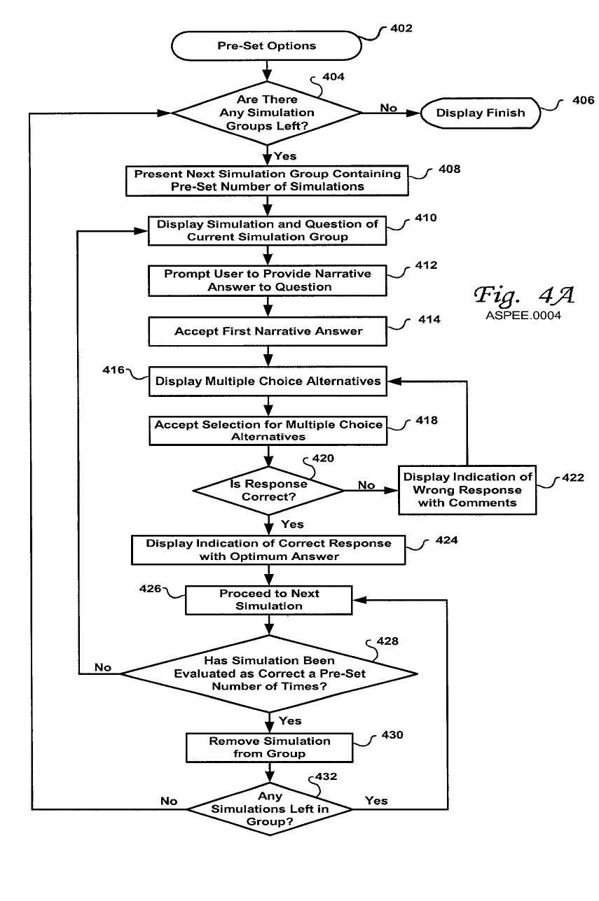

Referring to FIG. 3, the present invention can be implemented in a computerized network environment 300. Namely, multiple users 302, 304, and 306 can access the program 312 invention loaded on a remote machine 310. The connection between any user and the remote machine 310 can be through a computer network or over the Internet 308. Indeed, in a one embodiment, the program that implements the present training method is accessed over the world wide web portion of the Internet. Use of the Internet is particularly useful when the user is located in a remote location. For instance, training can occur any time of day or night, from the user's home or from a hotel. The training can be accomplished before a new-hire physically reports for his job. Likewise, the creation of the training course can be accomplished during a manager's free time at night from home, rather than having it interfere with his more pressing job duties during the work day.

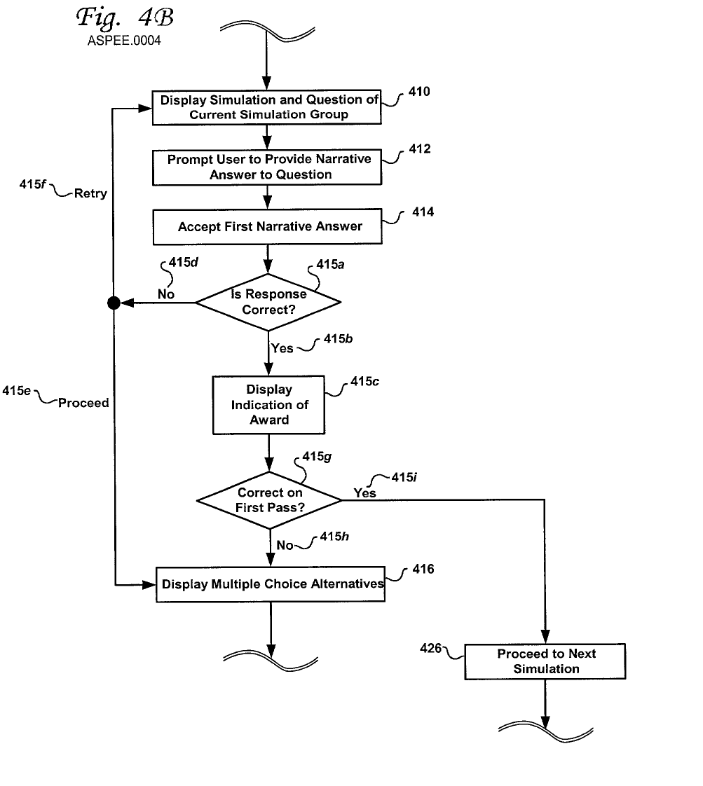

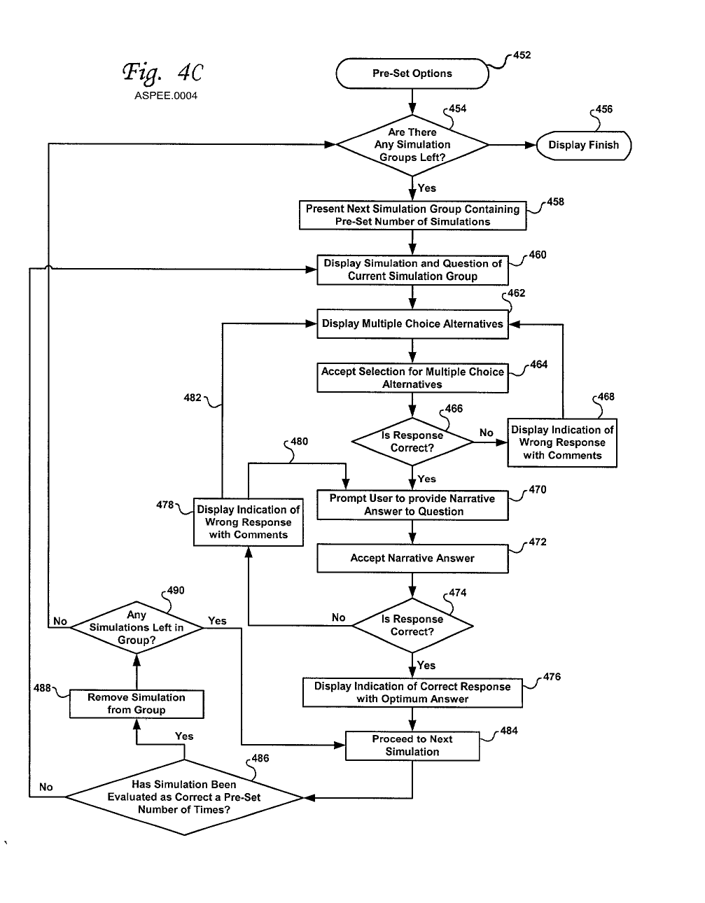

Referring to FIGS. 4A and 4C, the steps of two alternative embodiments of the improved training method of the present invention are illustrated. A course must first be created as discussed above. Certain options 402 in can be pre-set by the employer before the course is used by the trainee. For example, the course might have several groups of simulations. Each simulation group can have several or many individual simulations contained therein. Thus, one option might be the number of simulations within any single group. Another option might be the number of times that a trainee had to answer any particular simulation correctly. Another option might be method of evaluating whether a narrative answer was correct, and whether to grade the narrative answer or the selection from the multiple choice options. Another option might be selecting which alternative methodology is employed for each simulation group.

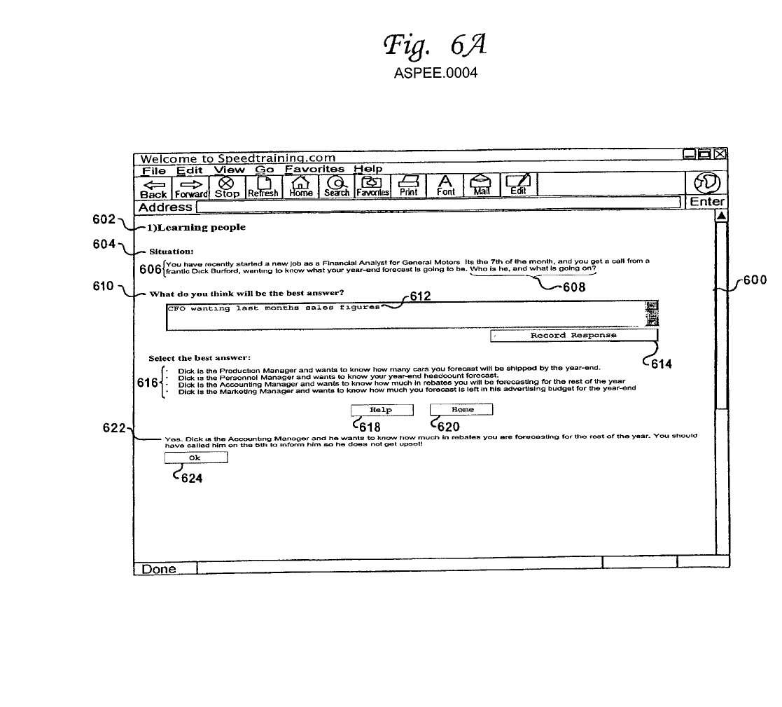

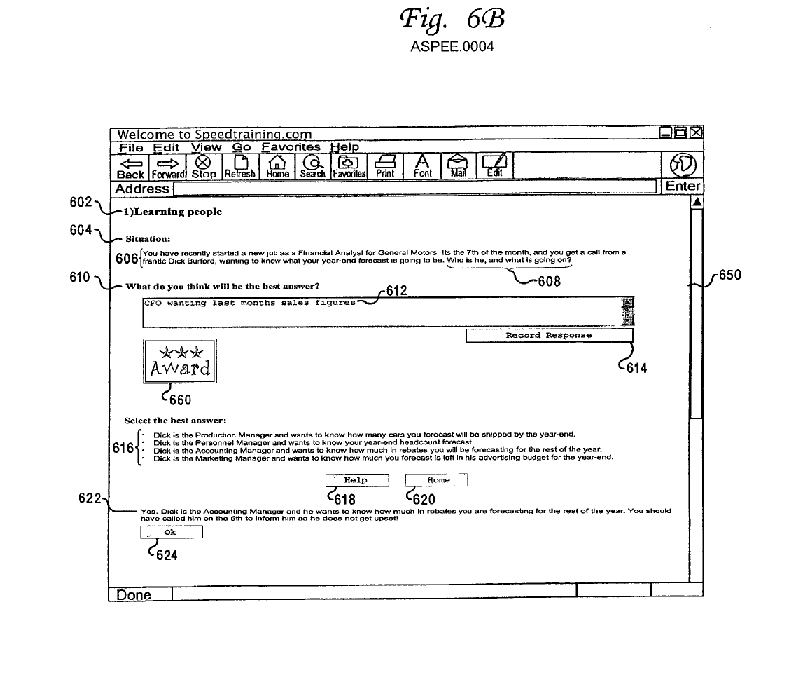

Once the options are selected, the program that constitutes the present invention must determine if there are any simulation groups left to present. In one embodiment of the present invention, as shown in FIG. 4A, the program determines 404 whether there are any simulation groups remaining. If not, then the program displays finished 406. If there are groups left to present, the program works with the next simulation group 408. As mentioned above, that group will contain a predetermined number of simulations. An initial simulation and question will be presented 410. For example, FIG. 6A illustrates a simulation 600 according to the embodiment of the present invention illustrated in FIG. 4A. The simulation involves the general topic of learning people 602 within an organization. The situation 604 involves a scenario 606 that might arise. A query 608 is presented to the trainee. He is prompted 610 to provide his best narrative answer. The answer is entered 612 and recorded 614.

The flow of this method is shown in FIG. 4A with steps 412 and 414. Once the response is recorded, a set of multiple choice alternatives 616 will be presented to the trainee, as shown in FIG. 6A. In this example, four choices are given. In the flow chart of FIG. 4A, this is represented with step 416. The user selects an answer from the set 418. The program decides if the selection is correct 420. If not, it displays an indication of a wrong response along with comments. The program redisplays the multiple choice answers again and the user again selects a response. This continues until the user selects the optimum answer. Once the optimum answer is selected, the program displays an indication of a correct response 424. FIG. 6A illustrates a display 622 the user would see with a correct answer. The user selects 624 to continue.

The program then proceeds to the next simulation 426. The program must decide whether the next simulation has been evaluated as correct a pre-set number of times 428. In other words, if that answer has already been answered correctly, for example, three times already, the simulation is removed from the group 430. The process is repeated. Once a simulation has been adequately mastered, it is removed from the group and the program decides if there are any simulations left in the group. If so, the process proceeds to step 426 and then back to step 410. Once all the simulations are mastered, then the program decides if there are any simulations left in the group 432. If not, the process proceeds back to step 404.

A variation of the embodiment of the invention shown in FIG. 4A. is included as FIG. 4B. Referring now to FIGS. 4A, 4B, and 6B, as in the parent embodiment, the variation of the program also determines 404 whether there are any simulation groups remaining. If not, then the program displays finished 406. If there are groups left to present, the program works with the next simulation group 408. As mentioned above, that group will contain a predetermined number of simulations. An initial simulation and question will be presented 410. As in the parent embodiment shown in FIG. 4A, the variation of the parent embodiment also displays a simulation 410 and presents a query 412 is to the trainee. FIG. 6B illustrates a simulation 650 according to the variation of the embodiment of the present invention illustrated in FIG. 4A and 4B. As previously shown in the parent embodiment, the variation simulation involves the general topic of learning people 602 within an organization. The situation 604 involves a scenario 606 that might arise. A query 608 is presented to the trainee. He is prompted 610 to provide his best narrative answer. The answer is entered 612 and recorded 614.

The flow of this variation method is shown in FIGS. 4A and 4B with steps 412 and 414. However, as shown in FIG. 4B, under the variation of the embodiment of the invention shown in FIG. 4A, the variation program analyzes the trainee's narrative typed response for pre-defined keywords that indicate the correctness of the trainee's answer to the posed query.

Based upon an identification of pre-defined keywords in the narrative, the system determines by conventional logic 415a as to its accuracy whether yes 415b, if it contains a sufficient number of keywords, or no 415d, if it does not contain a sufficient number of keywords. If no 415d, operation of the system may advance at the discretion of the system operator via two alternative predefined paths.

If via retry path 415f, the system once again presents the same situation/simulation and instructs the trainee to enter another narrative response describing his proposed solution to the presented situation/simulation. As with his first-time narrative answer, if his second-time narrative does not contain a sufficient number of pre-determined keywords, the system returns via no answer path 415d. However, if the narrative answer now contains a sufficient number of keywords, the system proceeds as by yes path 415b to display an indication of award 415c (shown as 660 in FIG. 6B) prior to proceeding on to the display of multiple choice solutions 416 as in the parent embodiment shown in FIG. 4A.

Alternatively, if via proceed path 415e, the system advances directly to display the multiple choice solutions 416 as in the parent embodiment shown in FIG. 4A. It should be noted that the loop via no path 415d may be set by the training supervisor to repeat so long as the trainee's narrative answer does not contain a sufficient number of keywords or to repeat a finite number of times prior to advancing on to display the multiple choice solutions 416 as in the parent embodiment shown in FIG. 4A.

Referring again to FIG. 4B, another feature of the variation to the FIG. 4A embodiment of the present invention, is that the variation methodology determines by conventional logic 415g whether the trainee's narrative response is correct on the trainee's first pass. If no 415h, the system proceeds to rejoin the parent embodiment method and present a set of multiple choice alternatives 416 to the trainee, as illustrated in FIG. 6B at 616. However, if yes 415i, the system skips the related multiple choice question and immediately proceeds to the next simulation 426.

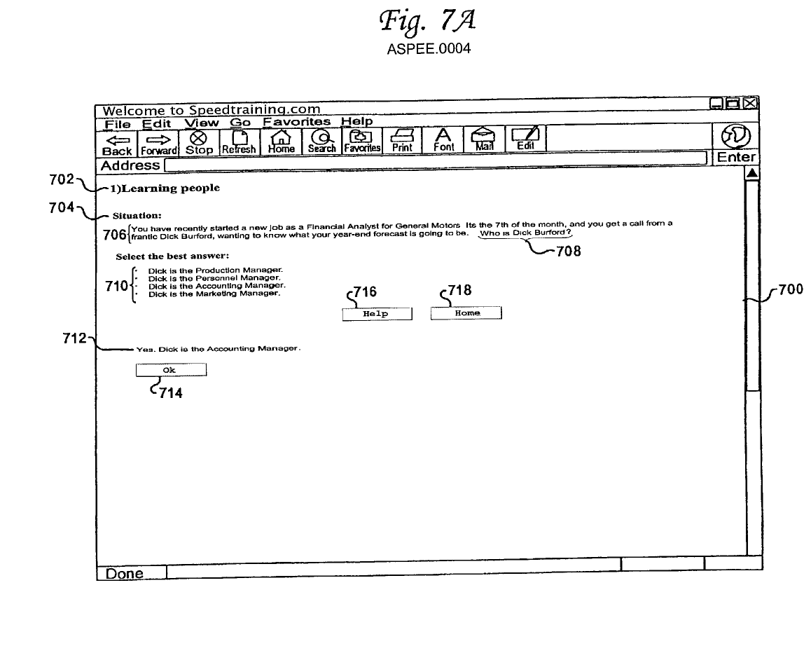

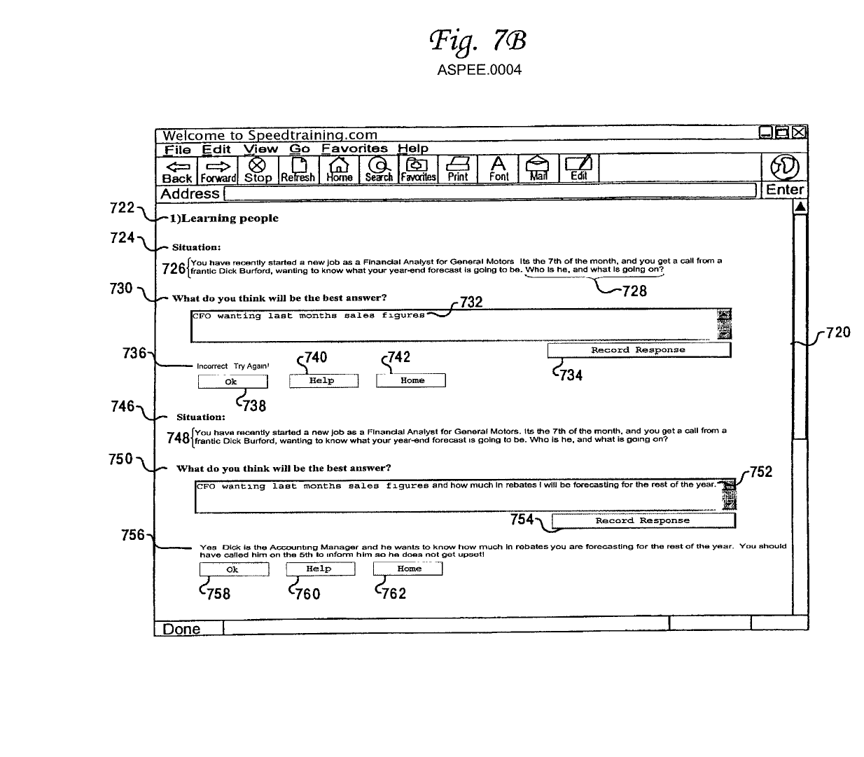

In an alternative embodiment of the present invention, as shown in FIG. 4C, the program determines 454 whether there are any simulation groups remaining. If not, then the program displays finished 456. If there are groups left to present, the program works with the next simulation group 458. As mentioned above, that group will contain a predetermined number of simulations. An initial simulation and question will be presented 460. For example, FIG. 7A illustrates a simulation 700 according to the embodiment of the present invention illustrated in FIG. 4C. The simulation involves the general topic of learning people 702 within an organization. The situation 704 involves a scenario 706 that might arise. A query 708 is presented to question the trainee. A set of multiple choice alternatives 710 is next presented to the trainee. In this example, four choices are given. In the flow chart of FIG. 4C, this is represented with step 462. The user selects an answer from the set 464. The program decides if the selection is correct 466. If not, it displays an indication of a wrong response along with comments. The program redisplays the multiple choice answers again and the user again selects a response. This continues until the user selects the optimum answer. Once the optimum answer is selected, the program displays an indication of a correct response. FIG. 7A illustrates a display 712 the user would see with a correct answer. The user selects an on-screen button 714 to continue.

A related situation/simulation is next presented with instructions to prepare a narrative solution 470. For example, FIG. 7B illustrates a simulation 720 of a query requesting a narrative response according to the embodiment of the present invention illustrated in FIG. 4C. The simulation again involves the general topic of learning people 722 within an organization. The situation 724 involves a scenario 726 that might arise. A query 728 is presented to question the trainee. The trainee is prompted 730 to provide his best narrative answer. The answer is entered 732 and recorded 734.

The flow of this method is shown in FIG. 4C with steps 470 and 472. Once the response is recorded, the program determines whether the response contains a sufficient number of pre-determined keywords. If the narrative response does not contain a sufficient number of keywords, the program displays an indication 736 that the answer is incorrect. By pressing an on-screen button 738, the trainee advances the program.

At this point, the system then returns via one of two alternative paths to again pose a query. By following path 480 the system once again presents the same situation/simulation and instructs the trainee to enter another narrative response describing his proposed solution to the presented situation/simulation as represented by rectangle 470. By following alternative path 482, the system once again returns to the same set of related multiple choice solutions (rectangle 462) which are again presented, and the trainee is again asked to make a selection, whence operation again proceeds as previously described.

If path 480 is elected, the system once again presents the same situation 746 involving the same scenario 748 and again prompts 750 the trainee to enter a narrative response describing his proposed solution. The answer 752 is entered and recorded 754. As with the first-time narrative answer, if the second-time narrative does not contain a sufficient number of pre-determined keywords, the program displays, as previously described, an indication that the answer is incorrect. However, if the narrative answer now contains a sufficient number of keywords, the system proceeds to display an indication 756 that the narrative response 752 is correct.

The program then proceeds to the next simulation 484. The program must decide whether the next simulation has been evaluated as correct a pre-set number of times 486. In other words, if that answer has already been answered correctly, for example, three times already, the simulation is removed from the group 488. The process is repeated. Once a simulation has been adequately mastered, it is removed from the group and the program decides if there are any simulations left in the group. If so, the process proceeds to step 484 and then back to step 460. Once all the simulations are mastered, then the program decides if there are any simulations left in the group 490. If not, the process proceeds back to step 454.

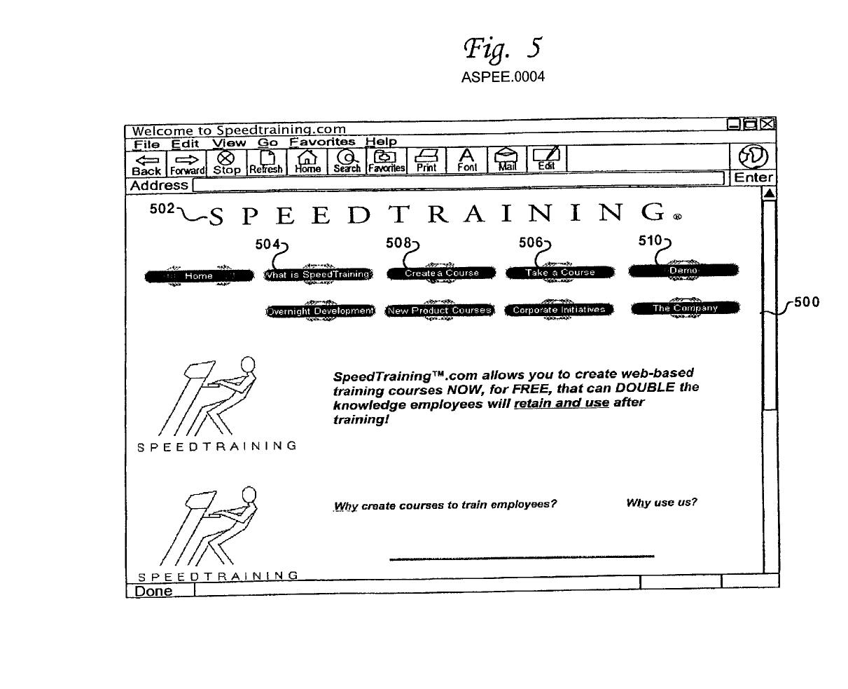

As mentioned above, the present invention can be accessed by several methods. For example, the program can be supplied on a medium for use on a single computer. Once installed, the program can be used to create a simulation group. Then, a trainee can use the same computer to take the course. Alternatively, the program could be stored on a server on a local area network (LAN) or wide area network (WAN). An employer at one station could create the simulation group while an employee trains on another client machine. In one embodiment, the program and courses are accessible over the Internet. FIG. 5 illustrates a typical sign-on screen 500 that would be seen by a user. A banner 502 announces the name of the site. An informational choice 504 can be selected. Alternatively, the user could choose to take a course 506 or to create a course 508 or to take a demonstration simulation 510.

It will now be evident to those skilled in the art that there has been described herein an improved computer-based learning system that through a combination of repetitive narrative solutions and multiple choice questions greatly facilitates trainee learning, improving significantly the retention of information over existing training methods.

Although the invention hereof has been described by way of a preferred embodiment, it will be evident that other adaptations and modifications can be employed without departing from the spirit and scope thereof. For example, some of the steps in the system procedure could be conducted mechanically in addition to those conducted electrically. The terms and expressions employed herein have been used as terms of description and not of limitation; and thus, there is no intent of excluding equivalents, but on the contrary it is intended to cover any and all equivalents that may be employed without departing from the spirit and scope of the invention.

1. A method in a data processing system for training a user, said method comprising the steps of:
(a) selecting a set of options for evaluating the performance of the user;
(b) presenting a first simulation group containing at least one situation/simulation therein;
(c) presenting a first situation/simulation and a query to the user; and
(d) presenting a selection of alternatives to the user, wherein one of said alternatives is an optimum answer.

2. The method of claim 1 further comprising:
(e) accepting a user selection of one of said selection of alternatives; and
(f) displaying a first indicator of whether the accepted selection is the optimum answer.

3. The method of claim 2 further comprising redisplaying the selection of alternatives if the user selection is incorrect.

4. The method of claim 2 further comprising:
(g) presenting a second situation/simulation and query to the user if said user selection is correct;
(h) accepting a narrative answer from the user to said second query;
(i) determining whether said answer contains a sufficient number of keywords; and
(j) displaying a second indicator of whether said answer is correct.

5. The method of claim 4 further comprising redisplaying said second situation/simulation and query to the user if the answer is incorrect.

6. The method of claim 4 further comprising redisplaying said first situation/simulation and query to the user if the answer is incorrect.

7. The method of claim 4 further comprising displaying a next situation/simulation if the user answer is correct.

8. The method of claim 1 wherein selecting a set of options further comprises determining a number of times that a user must properly evaluate a simulation before it is removed from the simulation group.

9. A computer program product on a computer useable medium, for use in a data processing system for training a user with a plurality of simulations and answers, the computer program product comprising:
(a) first instructions for selecting a set of options for evaluating the performance of the user;
(b) second instructions for presenting a first simulation group containing at least one situation/simulation therein;
(c) third instructions for presenting a first situation/simulation and query to the user; and
(d) fourth instructions for presenting a selection of alternatives to the user,
wherein one of said alternatives is an optimum answer.

10. The computer program product of claim 9 further comprising:
(e) fifth instructions for accepting a user selection of one of said selection of alternatives; and
(f) sixth instructions for displaying a first indicator of whether the accepted selection is the optimum answer.

11. The computer program product of claim 9 further comprising:
(g) seventh instructions for redisplaying the selection of alternatives if the user selection is incorrect.

12. The computer program product of claim 9 further comprising:
(h) eighth instructions for presenting a second situation/simulation and query to the user if said user selection is correct; and
(i) ninth instructions for accepting a narrative answer from the user to said second query;
(j) tenth instructions for determining whether said answer contains a sufficient number of keywords; and
(k) eleventh instructions for displaying a second indicator of whether said answer is correct.

13. The computer program product of claim 12 further comprising instructions for redisplaying said second situation/simulation and query to the user if the answer is incorrect.

14. The computer program product of claim 12 further comprising instructions for redisplaying said first situation/simulation and query to the user if the answer is incorrect.

15. A method in a data processing system for training a user, said method comprising the steps of:
(a) selecting a set of options for evaluating the performance of the user;
(b) presenting a first simulation group containing at least one situation/simulation therein;
(c) presenting a first situation/simulation and a query to the user;
(d) accepting a narrative answer from the user to said query;
(e) determining whether said answer contains a sufficient number of keywords; and
(f) displaying a first indicator of whether said answer is correct.

16. The method of claim 15 further comprising redisplaying said first situation/simulation and query to the user if the answer is incorrect.

17. The method of claim 15 further comprising displaying an indication of award if the answer is correct.

18. The method of claim 17 further comprising immediately proceeding to a next situation/simulation when said answer is correct on the first pass.

19. The method of claim 18 further comprising:
(g) Presenting a selection of alternatives to the user, wherein one of said alternatives is an optimum answer.

20. The method of claim 19 further comprising:
(h) accepting a user selection of one of said selection of alternatives; and
(i) displaying an indicator of whether the accepted selection is the optimum answer.
